(19) United States
(12) Patent Application Publication
(10) Pub. No.: US 2025/0388405 A1
(43) Pub. Date: Dec. 25, 2025

(54) METHODS OF STORING HYDROGEN IN SALT CAVERNS USING FLUID DERIVATIVES

(71) Applicant: Saudi Arabian Oil Company, Dhahran (SA)

(72) Inventors: Katherine Leigh Hull, Houston, TX (US); Simrat Singh, Houston, TX (US); Mohammad Hamidul Haque, Katy, TX (US); Younane N. Abousleiman, Norman, OK (US)

(21) Appl. No.: 18/752,050

(22) Filed: Jun. 24, 2024

(51) Int. Cl. B65G 5/00

(52) U.S. Cl. CPC B65G 5/005

(57) ABSTRACT

Methods for storing hydrogen in subterranean salt caverns using chemical hydrogen carriers.

### TECHNICAL FIELD

This document relates to chemical hydrogen carriers and storage of the carriers in subterranean salt caverns.

### BACKGROUND

Anthropogenic CO₂ emissions continue to rise steadily due to the global energy infrastructure based on fossil fuels. In order to reduce atmospheric CO₂ accumulation, new energy sources are needed, including low-carbon energy production and storage. Hydrogen has emerged as a potential low-carbon energy carrier. However, in order to enable hydrogen for long-term energy storage, hydrogen storage must occur at scales large enough to produce terawatt hours (TWh) of energy. Since hydrogen gas has a very low volumetric density (0.0838 kg m⁻³ at 1 atm and 20° C.), surface facilities do not have the required storage capacity.

Hydrogen storage in subsurface rock formations is a promising solution for energy storage and distribution. The suitability of rock formations for hydrogen storage depends on various factors, including porosity, permeability, geology, and geochemistry. There are many challenges associated with hydrogen storage and production in subsurface formations, including diffusion/leakage from the formation, microbial activity, and fault leakage.

One of the most promising rock formations for storing large volumes of hydrogen in the subsurface is salt caverns. Salt caverns are impermeable and can have a large storage capacity. Storing hydrogen gas in salt caverns presents several challenges due to the unique properties of hydrogen gas. Although salt formations have very low porosity and permeability, hydrogen as a small molecule can diffuse through the salt walls, leading to potential leakage and loss of stored gas. Hydrogen gas also has the ability to permeate and weaken metals, including the structural components of salt caverns. Over time, this can lead to embrittlement and reduce the integrity of the cavern, increasing the risk of leaks or even structural failure. Another challenge is that hydrogen is highly flammable and can form explosive mixtures with air. Managing the safety risks associated with storing large quantities of hydrogen in a confined space like a salt cavern requires stringent safety protocols and mitigation measures to prevent accidents or uncontrolled releases.

### SUMMARY

This disclosure describes compositions and methods for storing hydrogen in subterranean salt caverns.

In some embodiments, a method of subterranean hydrogen storage includes pumping a chemical hydrogen carrier into a subterranean salt cavern, wherein the chemical hydrogen carrier comprises methyl formate, methanol, methylcyclohexane, formic acid, or ammonium formate, or any combination thereof, and pumping a cushion gas into the subterranean salt cavern.

The details of one or more embodiments of the disclosure are set forth in the accompanying drawings and the description that follows. Other features, objects, and advantages of the disclosure will be apparent from the description and drawings, and from the claims.

### DESCRIPTION OF DRAWINGS

FIG. 1 is an example schematic of a subterranean salt cavern suitable for hydrogen storage.

FIG. 2 shows a flow chart of an example method of subterranean hydrogen storage.

FIG. 3A is an example SEM image of a halite sample before treatment with methyl formate.

FIG. 3B is an example SEM image of a halite sample after treatment with methyl formate.

FIG. 4A is an example SEM image of an anhydrite sample before treatment with methyl formate.

FIG. 4B is an example SEM image of the anhydrite sample after treatment with methyl formate.

FIG. 5A is a set of atomic force microscopy force curves of an anhydrite sample before methyl formate treatment.

FIG. 5B is a set of atomic force microscopy force curves of an anhydrite sample after methyl formate treatment.

FIG. 5C is the resulted peak surface force for untreated anhydrites and anhydrites treated with methyl formate.

FIG. 5D is a set of surface forces measured on untreated and treated halite samples treated with methyl formate, ammonium formate, and brine and N₂ at 40° C.

FIG. 6A is a map of surface forces in a Bruker AFM plot for untreated anhydrites.

FIG. 6B is a map of surface forces in a Bruker AFM plot for anhydrites treated with methyl formate.

Like reference symbols in the various drawings indicate like elements.

### DETAILED DESCRIPTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Provided in this disclosure are compositions and methods for hydrogen storage in salt caverns. The compositions and methods described herein address the challenges associated with large-volume storage and production of hydrogen in salt caverns, by storing and producing hydrogen in chemical hydrogen carriers. Chemical hydrogen carriers are compounds where hydrogen is released through a chemical reaction. In addition, the chemical hydrogen carrier can be regenerated by loading hydrogen on to a precursor to generate the carrier through a chemical reaction. Example chemical hydrogen carriers include ammonia (NH₃), formic acid (HCOOH), methyl formate (CH₃COOH), methanol (CH₃OH), methylcyclohexane (C₇H₁₄), and ammonium formate (CH₅NO₂). Chemical hydrogen carriers offer higher energy storage capacity than other hydrogen storage techniques. For example, chemical hydrogen carriers have a higher volumetric energy density (kWh/L) than hydrogen gas. In some embodiments, the chemical hydrogen carriers require additional reactants for hydrogen release once returned to the surface.

The chemical hydrogen carriers described herein exhibit improved properties compared to other types of hydrogen storage materials. For example, metal hydrides such as sodium alanate (NaAlH₄), lithium borohydride (LiBH₄), and magnesium hydride (MgH₂) can be used to store and release hydrogen. However, the chemical reactions required to release hydrogen from metal hydrides have slow reaction kinetics and high operating temperatures. Further, metal hydrides are highly reactive with water and will readily decompose outside of rigorous anhydrous conditions. In another example, sorption materials such as metal-organic frameworks (MOFs), zeolites, carbon-base materials such as nanoparticles, nanotubes (CNTs), and graphene can be used as hydrogen storage materials. However, the deep locations of salt caverns make the placement, replacement, and activation of solid sorption materials prohibitively difficult to use as hydrogen storage materials.

In contrast, the chemical hydrogen carriers of the present disclosure can be used to store hydrogen in salt caverns. Chemical hydrogen carriers are more easily stored in and retrieved from a salt cavern, compared to solid sorption materials, and are more dense than gaseous hydrogen storage materials. Further, chemical hydrogen carriers exhibit minimal reactivity with the salt surfaces of the cavern walls. Minimal reactivity is defined by measuring the dissolution of the salt surface by the chemical hydrogen carrier under the temperature conditions of the salt cavern. In some embodiments, the chemical hydrogen carrier is modified to achieve inertness with salt cavern walls. For example, the concentration or pH of the chemical hydrogen carrier can be modified. In another example, a polar hydrogen carrier that could dissolve or react with salt surfaces can be saturated with salt to prevent dissolution. In some embodiments, an additive is added to reduce the reactivity of the chemical hydrogen carrier with the salt surface. In some embodiments, the chemical hydrogen carrier is dispersed in a nonpolar liquid with no reactivity to the salt walls.

In addition, the chemical hydrogen carriers of the present disclosure are nontoxic. Accordingly, these carriers can be used in subterranean formations without minimal concerns about a detrimental environmental effect. Further, given the inert nature of the chemical hydrogen carriers, there are fewer safety concerns than the use of potentially explosive materials, such as hydrogen gas.

The chemical hydrogen carriers have a relatively high hydrogen content. For example, greater than 1% by weight, greater than 2% by weight, greater than 3% by weight, greater than 4% by weight, greater than 5% by weight, greater than 6% by weight, greater than 7% by weight, greater than 8% by weight, greater than 9% by weight, or greater than 10% by weight. In some embodiments, the chemical hydrogen carrier is dispersed in a neutral liquid and enriched with doses of pure hydrogen to yield an enriched chemical hydrogen carrier. In some embodiments, the enriched chemical hydrogen carrier has a hydrogen content of greater than 4% by weight, greater than 5% by weight, greater than 6% by weight, greater than 7% by weight, greater than 8% by weight, greater than 9% by weight, or greater than 10% by weight.

In some embodiments, the chemical hydrogen carrier includes methyl formate, methanol, methylcyclohexane, formic acid, ammonium formate, or ammonia, or any combination thereof. In some embodiments, the chemical hydrogen carrier is methyl formate. In some embodiments, the chemical hydrogen carrier is methanol. In some embodiments, the chemical hydrogen carrier is formic acid. In some embodiments, the chemical hydrogen carrier is ammonium formate. In some embodiments, the chemical hydrogen carrier is methylcyclohexane. In some embodiments, the chemical hydrogen carrier is ammonia. Table 1 list the characteristics of several chemical hydrogen carriers that can be stored in a salt cavern. The chemical hydrogen carriers in Table 1 can be stored as a neat material, as a combination of materials, or dissolved or dispersed in a solvent. In some embodiments, the chemical hydrogen carriers are combined. For example, ammonium formate dissolved in formic acid or ammonium formate dissolved in methyl formate. In this example, both the solute and the solvent are liquid hydrogen carriers, which maximized the amount of hydrogen stored for a given volume. Other combinations of chemical hydrogen carriers can include a solute and solvent that are both hydrogen carriers, which maximizes hydrogen storage in a given volume.

TABLE 1
Characteristics of Example Chemical Hydrogen Carriers

| | Methyl | | Formic | Ammonium | |
|---|---|---|---|---|---|
| | Formate | Methanol | Acid | Formate | Ammonia |
| Formula | C₂H₄O₂ | CH₄O | CH₂O₂ | CH₅NO₂ | NH₃ |
| Molecular Weight | 60.05 | 32.04 | 46.03 | 63.06 | 17.03 |
| (g/mol) | | | | | |
| Melting Point | −100 | −98 | 8.2-8.4 | 116 | −78 |
| (° C.) | | | | | |
| Boiling Point | 31.5 | 64.7 | 100.8 | 180 | 60 |
| (° C.) | | | | | |
| Density | 974 | 791 | *1220 | 1185 | 102.3 |
| (20° C., kg/m³) | | | | | |
| Vapor Pressure | 63.5 | 13.0 | 4.6 | N/A | 857 |
| (20° C., kPa) | | | | | |
| Viscosity | 0.355 | 0.588 | 1.784 | N/A | *1.01 × 10⁻⁵ |
| (20° C., mPa · s) | | | | | |
| Flash Point | −27 | 52 | N/A | N/A | 132 |
| (° C.) | | | | | |
| Water Solubility | 330 | miscible | ~100 | 143 | *31 w/w % |
| (20° C., g/L) | | | | | |
| H2 Storage | 8.4 | 12.1 | 4.4 | 8.0 | 17.8 |
| (wt %) | | | | | |
| Energy Content | 2.76 | 3.45 | 1.78 | 3.2 | 3.3 |
| (kWh L⁻¹)** | | | | | |

*data at 25° C.
**0.0023 for H₂

Compared to storing hydrogen gas, chemical hydrogen carriers have a higher energy storage capacity. For example, a single salt cavern at 60° C. with 500,000 m³ storage capacity, the amount of hydrogen (0.0023 kWh/L) stored at 200 bar (20,000 kPa) yields 258 GWh energy. In comparison, methyl formate (2.76 kWh/L), which has a density slightly above 974 kg/m³, provides more than 1364 GWh, more than five times as much energy as hydrogen gas. This comparison does not account for material losses, where hydrogen as a light gas is expected to suffer more severe losses via various leakage pathways.

In some embodiments, a method for storing hydrogen includes pumping a chemical hydrogen carrier into a salt cavern. The chemical hydrogen carrier can be a solid, liquid, or gas. In some embodiments, the chemical hydrogen carrier is a solid and is dispersed in a liquid or gas before being pumped into a salt cavern. In some embodiments, the chemical hydrogen carrier is a liquid at surface conditions, and is pumped into the salt cavern as a liquid. Liquid chemical hydrogen carriers require the minimum amount of energy to pump and store hydrogen, compared to solid or gaseous hydrogen carriers. In some embodiments, the vapor pressure of the liquid hydrogen carrier is less than 1000 kPa at 20° C. For example, the vapor pressure can be less than 900 kPa at 20° C., less than 800 kPa at 20° C., less than 700 kPa at 20° C., less than 600 kPa at 20° C., less than 500 kPa at 20° C., less than 400 kPa at 20° C., or less than 200 kPa at 20° C. In some embodiments, the vapor pressure of the liquid hydrogen carrier is less than 100 kPa at 20° C. For example, the vapor pressure can be less than 90 kPa at 20° C., less than 80 kPa at 20° C., less than 70 kPa at 20° C., less than 60 kPa at 20° C., less than 50 kPa at 20° C., less than 40 kPa at 20° C., less than 30 kPa at 20° C., less than 20 kPa at 20° C., or less than 10 kPa at 20° C.

After placement of the chemical hydrogen carrier, a cushion gas is pumped into the salt cavern. In some embodiments, the cushion gas includes nitrogen, carbon dioxide, or methane.

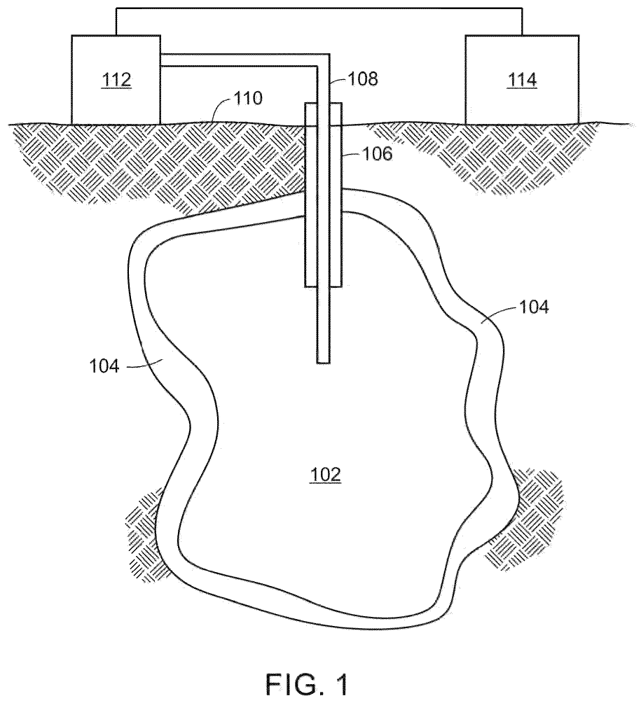

FIG. 1 shows an example schematic of a subterranean salt cavern suitable for hydrogen storage. The subterranean salt cavern 102 includes salt surfaces 104. A wellbore 106 can be drilled to provide access to the subterranean salt cavern 102. The chemical hydrogen carriers and cushion gas as described herein can be pumped into the subterranean salt cavern and/or retrieved from the subterranean salt cavern through a work string 108. The work string 108 can be coiled tubing, sectioned pipe, or other suitable tubing. In some embodiments, a pump truck 112 at the surface 110 can be used to pump the chemical hydrogen carriers and cushion gas into the subterranean salt cavern. In some embodiments, one or more instrument trucks 114 are provided at the surface 110. The instrument trucks can include a pumping control system. The control system can control the pump trucks 112. In some implementations, the instrument trucks 114 can include a separator unit in fluid communication with the work string 108. The separator unit can be used to separate components retrieved from the subterranean salt cavern.

In some embodiments of the method, the chemical hydrogen carrier can be retrieved from the subterranean salt cavern. To retrieve the chemical hydrogen carrier, the cushion gas is removed or displaced. In some embodiments, the cushion gas pressure is released from the salt cavern. In some embodiments, the cushion gas is pumped into the salt cavern, displacing the chemical hydrogen carrier.

In some embodiments of the method, a fluid, gas, or supercritical fluid is pumped into the salt cavern to displace the chemical hydrogen carrier. In some embodiments, the supercritical fluid includes CO₂, nitrogen, and/or methane. In some embodiments, the chemical hydrogen carrier is displaced to the surface and processed on the surface at a separator unit. For example, the separator unit can separate CO₂ from other components.

A method of subterranean hydrogen storage includes pumping a chemical hydrogen carrier into a subterranean salt cavern. The chemical hydrogen carrier includes methyl formate, methanol, formic acid, ammonia, methylcyclohexane, or ammonium formate, or any combination thereof. Next, a cushion gas is pumped into the subterranean salt cavern. In some embodiments, the chemical hydrogen carrier is dissolved or dispersed in a liquid or gas before the chemical hydrogen carrier is pumped into the subterranean salt cavern. In some embodiments, the chemical hydrogen carrier is dissolved or dispersed in Neutral liquids include nonpolar liquids that do not dissolve the predominantly halite salt walls.

In some embodiments, the vapor pressure of the chemical hydrogen carrier is less than 1000 kPa at 20° C. In some embodiments, the vapor pressure of the chemical hydrogen carrier is less than 100 kPa at 20° C. In some embodiments, the cushion gas includes nitrogen, carbon dioxide, or methane.

In some embodiments, the method includes monitoring the reactivity of the chemical hydrogen carrier with the salt surface of the subterranean salt cavern. In some embodiments, monitoring the reactivity of the chemical hydrogen carrier with the salt surfaces of the subterranean salt cavern includes monitoring the dissolution of the salt surface by the chemical hydrogen carrier.

In some embodiments, the chemical hydrogen carrier includes an inertness modification. The main reaction that can take place with the salt walls (predominantly comprised of halite (NaCl)) is dissolution by a polar solvent. Some hydrogen storage materials are polar, for example ammonia, formic acid, and methanol. These polar fluids can be pre-saturated with salt at the surface before pumping to ensure that additional dissolution does not take place in the salt cavern. The amount of salt required will vary from one storage material to another based on the solubility limit for each. Ammonium formate is a solid and can be one such salt that is dissolved in one of the liquid polar hydrogen storage materials such as formic acid. Sodium chloride can also be used, since the salt walls can be composed of the same salt. In some embodiments, the chemical hydrogen carrier includes ammonium formate dissolved in formic acid. In some embodiments, the chemical hydrogen carrier includes ammonium formate dissolved in methyl formate. In some embodiments, the chemical hydrogen carrier is enriched with pure hydrogen. In some embodiments, the chemical hydrogen carrier includes more than 1% by weight hydrogen, for example, more than 4% by weight hydrogen.

In some embodiments, the method further includes releasing the cushion gas from the salt cavern, or dispersing the cushion gas into the salt cavern. In some embodiments, the method further includes retrieving the chemical hydrogen carrier from the subterranean salt cavern. In some embodiments, retrieving the chemical hydrogen carrier from the subterranean salt cavern includes displacing the chemical hydrogen carrier to the surface. In some embodiments, displacing the chemical hydrogen carrier to the surface includes pumping a fluid, gas, or supercritical fluid into the subterranean salt cavern to displace the chemical hydrogen carrier to the surface. In some embodiments, the supercritical fluid includes carbon dioxide, nitrogen or methane.

In some embodiments, the method includes processing the retrieved chemical hydrogen carrier at the surface at a separator unit. In some embodiments, processing the retrieved chemical hydrogen carrier at the surface at a separator unit includes sorting CO₂ from other hydrogen carbon components.

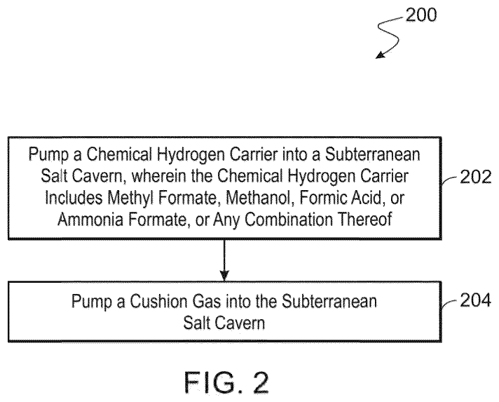

FIG. 2 shows a flow chart of an example method 200 of subterranean hydrogen storage. At 202, a chemical hydrogen carrier is pumped into a subterranean salt cavern. The chemical hydrogen carrier includes methyl formate, methanol, methylcyclohexane, formic acid, or ammonium formate, or any combination thereof. At 202, a cushion gas is pumped into the subterranean salt cavern.

### EXAMPLES

To assess the compatibility of potential chemical hydrogen carriers with salt cavern walls, a workflow was developed to assess the effects of the fluid on relevant salt samples. The workflow includes assessing polished salt surfaces before and after exposure to the chemical hydrogen carriers using scanning electron microscopy (SEM), atomic force microscopy (AFM), and nanoindentation. SEM and AFM imaging of salt surfaces provide insights into micro- and nanoscale changes to the structure and topology of the salt surfaces, including pocking, grain boundary weakening, and deposition. Nanoindentation provides insights in the mechanical integrity at or near the surface of the salt.

### Example 1: Methyl Formate

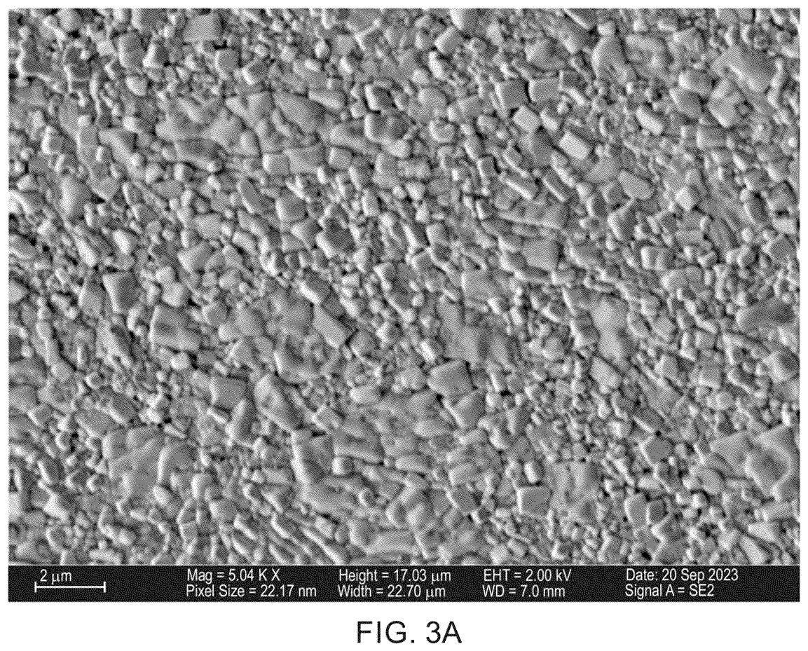

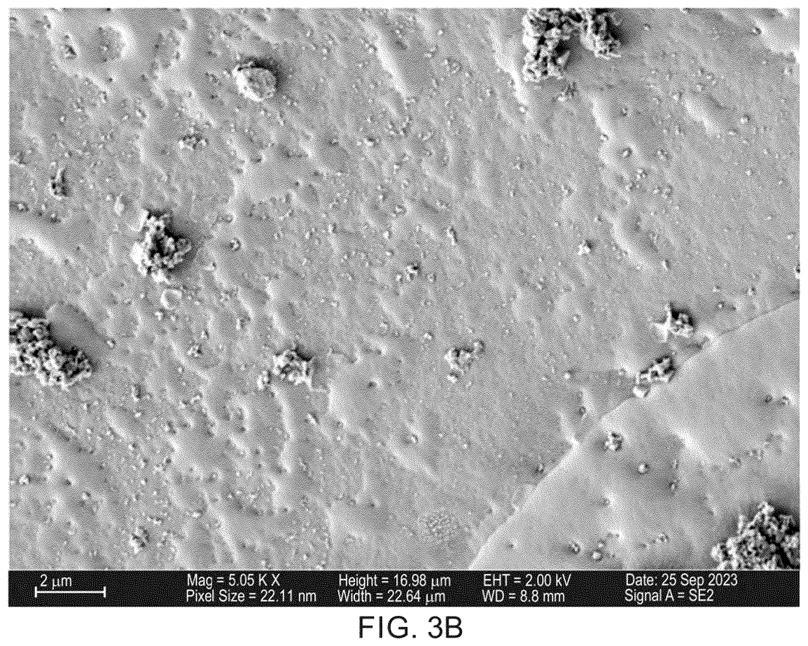

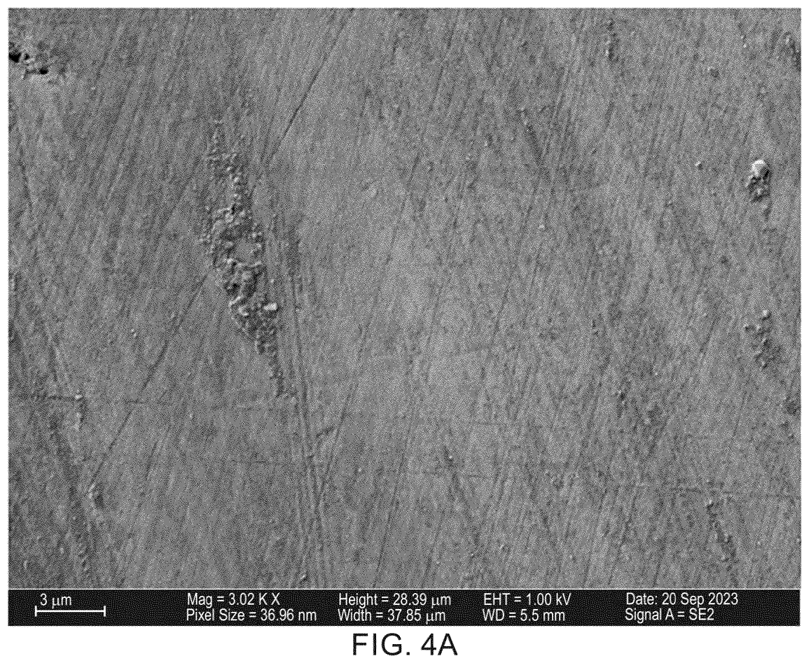

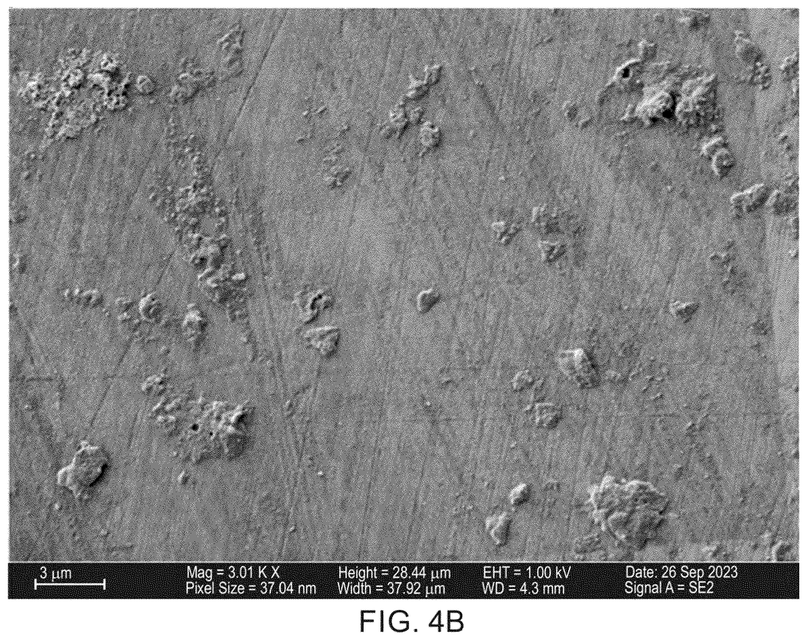

Methyl formate as a chemical hydrogen carrier was evaluated for its storage potential in salt caverns. Two salt samples, halite and anhydrite, were obtained and finely polished mechanically. The samples were first mechanically tested using a nanoindenter and then were imaged via AFM and SEM. The halite (0.1896 g) and anhydrite (0.2679 g) were placed in an autoclave with 8 mL of methyl formate and heated to 40° C. for 72 hours. After the heating period, the salt samples were removed from the liquid and rinsed with dichloromethane. The final masses of 0.1896 g halite and 0.2677 g anhydrite indicated no material loss. Similarly, halite and anhydrite samples in methyl formate at room temperature for 2 weeks also exhibited no mass change. FIG. 3A shows an example SEM image of a halite sample before treatment with methyl formate. FIG. 3B shows an example SEM image of a halite sample after treatment with methyl formate at 40° C. for 72 hours. FIG. 4A shows an example SEM image of an anhydrite sample before treatment with methyl formate. FIG. 4B shows an example SEM image of the anhydrite sample after treatment with methyl formate at 40° C. for 72 hours.

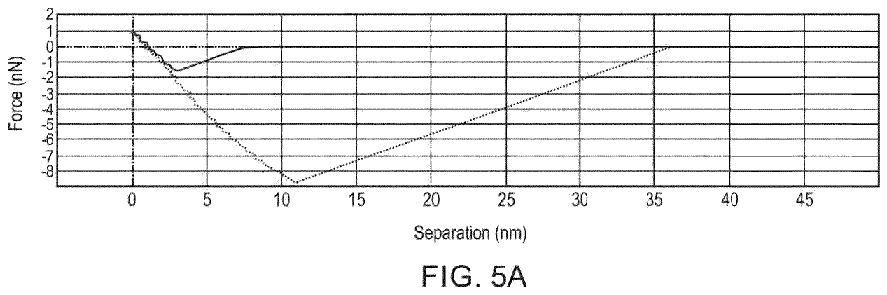

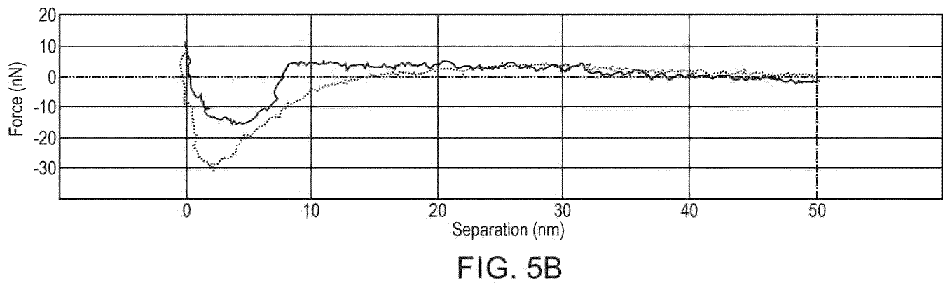

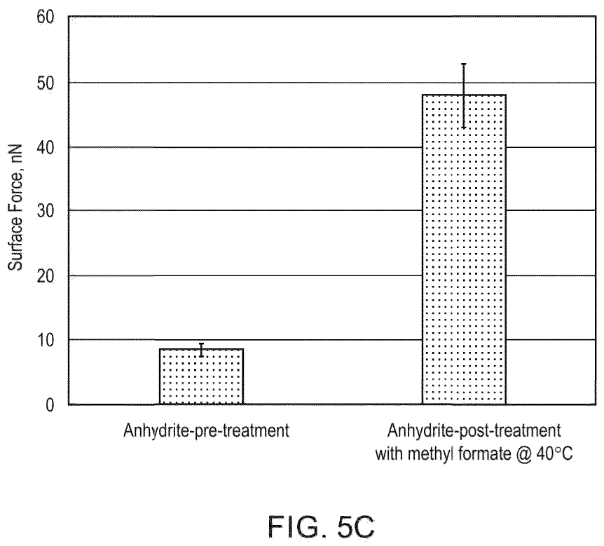

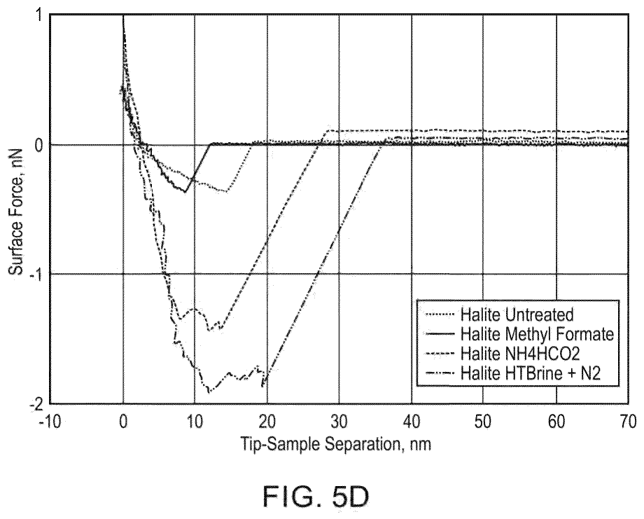

Before and after treatment, the surface forces exhibited by the outer most crystals located on the anhydrite samples were measured. FIGS. 5A and 5B show atomic force microscopy force curves of the anhydrite sample before methyl formate treatment (FIG. 5A) and after methyl formate treatment (FIG. 5B).

The force curves quantify the net force acting on the SiN tip as it approaches and retraces from the salt surface within less than 100 nm proximity. In FIGS. 5A and 5B, the solid line illustrates the AFM tip approaching the surface, and the dashed line illustrates the AFM tip retracting from the surface. The net resulted force (a combination of forces such as van der Waals, chemical, capillary condensation, electrostatic, electrochemical) is attractive in nature, pulling the tip towards the sample. This force also depends on the microstructural fabric and orientations with respect to the AFM tip shape, length, spring constant, resonance frequency. As the measurements shows the resulted peak surface force for untreated and treated anhydrites is around −9 nN (FIG. 5A) and −30 nN (FIG. 5B), respectively. This difference is shown in a bar graph format in FIG. 5C.

The surface force curves (surface force vs. tip-sample separation) correlate to multiple properties tied to the surface materials. Two main characteristics observable from the retrace curve (dotted curve in FIGS. 5A and 5B, the surface force when the tip starts moving away from the surface) are: (1) the bottom or minimum value of the force curve, indicating the maximum surface force itself, and (2) the duration or length of the surface force, indicating the duration when the force is active on the tip. Both surface force values and the duration are higher in treated anhydrite (FIG. 5B) than in untreated anhydrite (FIG. 5A). An increase in surface force (FIG. 5B) is an indication of deviation from reference (or clean surface properties) where a detrimental change took place on the grain structures, grain boundaries, or surface morphology. Therefore, when a hydrogen storage liquid reacts and alters the salt surface, the surface force increases compared to untreated/reference salt surface. Another example is shown in FIG. 5D, where surface forces were measured on untreated and treated halite (in methyl formate, NH₄HCO₂, brine and N₂ treated at 40° C.) samples. Except for methyl formate, the surface forces increase in the other two cases (NH₄HCO₂, and brine and nitrogen), indicating methyl formate is acting as a more suitable storage candidate. In addition, it was observed that the separation of the AFM tip from the surface (snap-off) was delayed with multiple bounces, indicating more damage on the anhydrite surface.

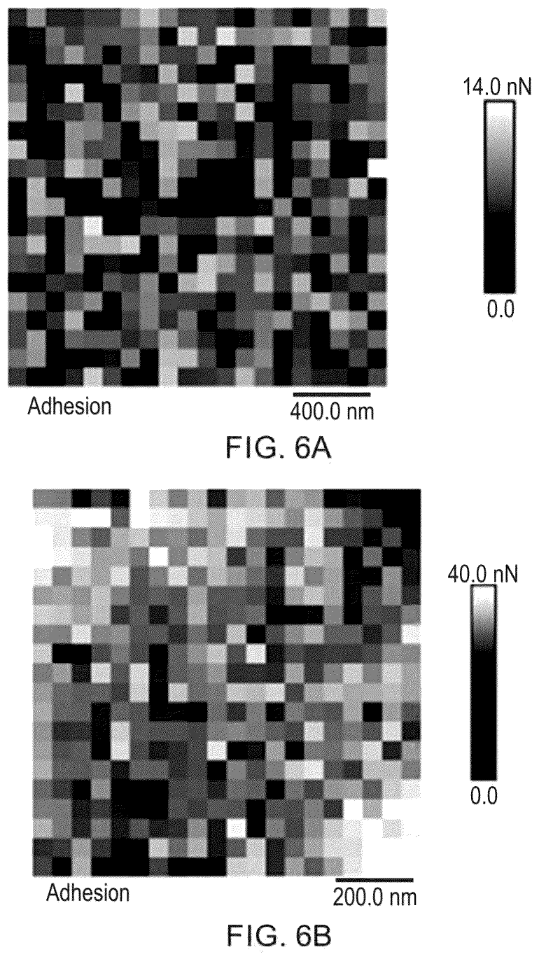

FIGS. 6A and 6B show maps of surface forces, also known as adhesion forces, in a Bruker AFM plot, taken on pre-treated (FIG. 6A) and post-treated (FIG. 6B) anhydrite samples. Each pixel is a force plot (force vs. separation) with a value corresponding to the minimum force for the retracting line.

As shown in this example, methyl formate exhibits negligible reactivity (i.e., dissolution behavior) towards the salt surface, making it a suitable chemical hydrogen carrier for use in a salt cavern.

### Embodiments

1. A method of subterranean hydrogen storage, the method comprising:
pumping a chemical hydrogen carrier into a subterranean salt cavern, wherein the chemical hydrogen carrier comprises methyl formate, methanol, methylcyclohexane, formic acid, or ammonium formate, or any combination thereof; and pumping a cushion gas into the subterranean salt cavern.

2. The method of embodiment 1, wherein the chemical hydrogen carrier is dissolved or dispersed in a liquid or gas before the chemical hydrogen carrier is pumped into the subterranean salt cavern.

3. The method of embodiment 1 or 2, wherein the chemical hydrogen carrier is dissolved or dispersed in a non-polar liquid.

4. The method of any one of embodiments 1-3, wherein the chemical hydrogen carrier is saturated with a salt.

5. The method of embodiment 4, wherein the salt is NaCl.

6. The method of any one of embodiments 1-5, wherein the vapor pressure of the chemical hydrogen carrier is less than 1000 kPa at 20° C.

7. The method of any one of embodiments 1-6, wherein the vapor pressure of the chemical hydrogen carrier is less than 100 kPa at 20° C.

8. The method of any one of embodiments 1-7, wherein the cushion gas comprises nitrogen, carbon dioxide, or methane.

9. The method of any one of embodiments 1-8, further comprising monitoring the reactivity of the chemical hydrogen carrier with the salt surfaces of the subterranean salt cavern.

10. The method of embodiment 9, wherein monitoring the reactivity of the chemical hydrogen carrier with the salt surfaces of the subterranean salt cavern comprises monitoring the dissolution of the salt surface by the chemical hydrogen carrier.

11. The method of any one of embodiments 1-10, wherein the chemical hydrogen carrier comprises methyl formate.

12. The method of any one of embodiments 1-11, wherein the chemical hydrogen carrier comprises ammonium formate dissolved in formic acid.

13. The method of any one of embodiments 1-11, wherein the chemical hydrogen carrier comprises ammonium formate dissolved in methyl formate.

14. The method of any one of embodiments 1-13, wherein the chemical hydrogen carrier is enriched with pure hydrogen.

15. The method of any one of embodiments 1-14, wherein the chemical hydrogen carrier comprises greater than 1% by weight hydrogen, and optionally greater than 4% by weight hydrogen.

16. The method of any one of embodiments 1-15, further comprising:
releasing the cushion gas from the subterranean salt cavern; or
dispersing the cushion gas into the subterranean salt cavern.

17. The method of embodiment 16, further comprising retrieving the chemical hydrogen carrier from the subterranean salt cavern.

18. The method of embodiment 17, wherein retrieving the chemical hydrogen carrier from the subterranean salt cavern comprises displacing the chemical hydrogen carrier to the surface.

19. The method of embodiment 18, wherein displacing the chemical hydrogen carrier to the surface comprises pumping a fluid, gas, or supercritical fluid into the subterranean salt cavern to displace the chemical hydrogen carrier to the surface.

20. The method of embodiment 19, wherein displacing the chemical hydrogen carrier to the surface comprises pumping a supercritical fluid into the subterranean salt cavern, wherein the supercritical fluid comprises carbon dioxide, nitrogen, or methane.

21. The method of any one of embodiments 17-20, further comprising processing the retrieved chemical hydrogen carrier at the surface at a separator unit.

22. The method of embodiment 21, wherein processing the retrieved chemical hydrogen carrier at the surface at a separator unit comprises sorting CO₂ from other hydrogen carbon components.

### Definitions

Unless otherwise defined, all technical and scientific terms used in this document have the same meaning as commonly understood by one of ordinary skill in the art to which the present application belongs. Methods and materials are described in this document for use in the present application; other, suitable methods and materials known in the art can also be used. The materials, methods, and examples are illustrative only and not intended to be limiting. All publications, patent applications, patents, sequences, database entries, and other references mentioned in this document are incorporated by reference in their entirety. In case of conflict, the present specification, including definitions, will control.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (for example, 1%, 2%, 3%, and 4%) and the sub-ranges (for example, 0.1% to 0.5%, 1.1% to 2.2%, and 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

The term “about” as used in this disclosure can allow for a degree of variability in a value or range, for example, within 10%, within 5%, or within 1% of a stated value or of a stated limit of a range.

As used in this disclosure, the terms “a,” “an,” and “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

In the methods described in this disclosure, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “solvent” as used in this disclosure refers to a liquid that can dissolve a solid, another liquid, or a gas to form a solution. Non-limiting examples of solvents are silicones, organic compounds, water, alcohols, ionic liquids, and supercritical fluids.

The term “room temperature” as used in this disclosure refers to a temperature of about 15 degrees Celsius (° C.) to about 28° C.

As used in this disclosure, “weight percent” (wt %) can be considered a mass fraction or a mass ratio of a substance to the total mixture or composition. Weight percent can be a weight-to-weight ratio or mass-to-mass ratio, unless indicated otherwise.

As used in this disclosure, the term “fluid” refers to liquids and gels, unless otherwise indicated.

As used in this disclosure, the term “subterranean” refers to any region under the surface of the earth, including under the surface of the bottom of the ocean.

A number of embodiments of the disclosure have been described. Nevertheless, it will be understood that various modifications may be made without departing from the spirit and scope of the disclosure.

What is claimed is:

1. A method of subterranean hydrogen storage, the method comprising:
pumping a chemical hydrogen carrier into a subterranean salt cavern, wherein the chemical hydrogen carrier comprises methyl formate, methanol, methylcyclohexane, formic acid, or ammonium formate, or any combination thereof; and
pumping a cushion gas into the subterranean salt cavern.

2. The method of claim 1, wherein the chemical hydrogen carrier is dissolved or dispersed in a liquid or gas before the chemical hydrogen carrier is pumped into the subterranean salt cavern.

3. The method of claim 2, wherein the chemical hydrogen carrier is dissolved or dispersed in a non-polar liquid.

4. The method of claim 1, wherein the chemical hydrogen carrier is saturated with a salt.

5. The method of claim 4, wherein the salt is NaCl.

6. The method of claim 1, wherein the cushion gas comprises nitrogen, carbon dioxide, or methane.

7. The method of claim 1, further comprising monitoring the reactivity of the chemical hydrogen carrier with the salt surfaces of the subterranean salt cavern.

8. The method of claim 7, wherein monitoring the reactivity of the chemical hydrogen carrier with the salt surfaces of the subterranean salt cavern comprises monitoring the dissolution of the salt surface by the chemical hydrogen carrier.

9. The method of claim 1, wherein the chemical hydrogen carrier comprises methyl formate.

10. The method of claim 1, wherein the chemical hydrogen carrier comprises ammonium formate dissolved in formic acid.

11. The method of claim 1, wherein the chemical hydrogen carrier comprises ammonium formate dissolved in methyl formate.

12. The method of claim 1, wherein the chemical hydrogen carrier is enriched with pure hydrogen.

13. The method of claim 1, wherein the chemical hydrogen carrier comprises greater than 1% by weight hydrogen, and optionally greater than 4% by weight hydrogen.

14. The method of claim 1, further comprising:
releasing the cushion gas from the subterranean salt cavern; or
dispersing the cushion gas into the subterranean salt cavern.

15. The method of claim 14, further comprising retrieving the chemical hydrogen carrier from the subterranean salt cavern.

16. The method of claim 15, wherein retrieving the chemical hydrogen carrier from the subterranean salt cavern comprises displacing the chemical hydrogen carrier to the surface.

17. The method of claim 16, wherein displacing the chemical hydrogen carrier to the surface comprises pumping a fluid, gas, or a supercritical fluid into the subterranean salt cavern to displace the chemical hydrogen carrier to the surface.

18. The method of claim 17, wherein displacing the chemical hydrogen carrier to the surface comprises pumping a supercritical fluid into the subterranean salt cavern, wherein the supercritical fluid comprises carbon dioxide, nitrogen, or methane.

19. The method of claim 15, further comprising processing the retrieved chemical hydrogen carrier at the surface at a separator unit.

20. The method of claim 19, wherein processing the retrieved chemical hydrogen carrier at the surface at a separator unit comprises sorting CO₂ from other hydrogen carbon components.
